(19) United States
(12) Patent Application Publication
(10) Pub. No.: US 2013/0204833 A1
(43) Pub. Date: Aug. 8, 2013

(54) PERSONALIZED RECOMMENDATION OF USER COMMENTS

(71) Applicants: Bo Pang, Sunnyvale, CA (US); Bee-Chung Chen, Mountain View, CA (US); Deepak K. Agarwal, Sunnyvale, CA (US)

(72) Inventors: Bo Pang, Sunnyvale, CA (US); Bee-Chung Chen, Mountain View, CA (US); Deepak K. Agarwal, Sunnyvale, CA (US)

(21) Appl. No.: 13/364,369

(22) Filed: Feb. 2, 2012

(51) Int. Cl. G06N 5/00; G06F 15/16

(52) U.S. Cl. 706/52; 709/206

(57) ABSTRACT

Techniques are described herein for facilitating the consumption of user-generated comments by determining which comments will be of most interest to each individual user. Once the comments that will be of most interest to a particular user are determined, the user-generated comments are presented to that user in a manner that reflects that user's predicted interest. A variety of factors may be used to predict, automatically, the interest each individual user would have in each user-generated comment. For example, interest predictions for a user may be based on the user's prior rating of comments, various types of profile and/or demographic information about the user, the user's social network connections, the authors of the comments, the author of the target subject matter, the user's propensity to comment, etc.

### FIELD OF THE INVENTION

The present invention relates to services that allow users to comment on items and, more specifically, to techniques for helping each user to consume the user comments in which the user is personally interested.

### BACKGROUND

Recent years have seen rapid growth in user-generated opinions online. User-generated opinions take many forms. For example, one common form of user-generated opinions is user reviews. It is common for popular items to receive an unmanageably large number of user reviews. For example, on a book-selling website, a best-selling book may receive over 1000 reviews. Similarly, on a service that allows users to review restaurants, a popular restaurant can garner over 1000 reviews.

Another common form of user-generated opinions comes in the form of user comments on blogs or news articles. Similar to reviewed items, news articles on popular topics may receive an unwieldy number of comments. For example, during the short period of time for which a major event is active, news stories on one single event can easily attract over ten thousand comments on popular online news sites.

Reviews and news/blog commentary are merely two examples of user-generated comments. As used herein, the term “user-generated comments” refers to any content, provided by users for online publication, in relation to subject matter that is published or being discussed online. The subject matter at which the user-generated comments are directed may include, but is not limited to, products, songs, movies, news articles, discussion topics, sports teams, services, etc.

Frequently, user-generated comments are published in conjunction with the subject matter to which the user-generated comments relate (the “target subject matter”). For example, the same webpage that has a news article may also include user comments related to the news article. Though entered in relation to a particular target subject matter, user-generated comments often do not actually express opinions about the target subject matter. For example, a user comment entered in relation to a news article may not actually have anything to do with the topic of the news article.

Given the vast quantity of user-generated comments that may be generated for a target subject matter, it important to present user-generated comments in a manner that allows them to be easily consumed. One approach to facilitating the consumption of user-generated comments is to generate summaries of the user-generated comments. Review summarization may involve, for example, (a) automatically or manually identifying ratable aspects, and (b) presenting overall sentiment polarity for each aspect.

Another technique for assisting user consumption of user-generated comments involves predicting the overall helpfulness of reviews in the hope of promoting those with better quality, where helpfulness is usually defined as some function over the percentage of users who found the review to be helpful. Both summarization and using a helpfulness rating focus on distilling subjective information that may be interesting to an average user.

However, whether opinion consumers are looking for quality information or just wondering what other people think, each may have different purposes or preferences that are not well represented by a generic average user. In light of the foregoing, it is desirable to provide techniques that allow users to more easily consume the user-generated comments in which they are personally interested, without having to wade through a potentially vast ocean of user-generated comments that they would find less interesting.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that illustrates how comments for the same article are presented in a different manner to three different users, according to an embodiment of the invention; and

FIG. 2 is a block diagram of a computer system upon which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques are described herein for facilitating the consumption of user-generated comments by determining which comments will be of most interest to each individual user. Once the comments that will be of most interest to a particular user are determined, the user-generated comments are presented to that user in a manner that reflects that user's predicted interest. For example, from 1000 reviews of a movie, each user may be presented with the 20 reviews that are predicted to be of most interest to the user. Because the predictions are personalized, different users are presented with different sets of 20 reviews, all for the same movie.

As another example, all users may be presented the same 1000 reviews, but the reviews may be ordered based on predictions of how interested each individual user would be in each review. Instead of or in addition to filtering and ranking user-generated comments based on each user's predicted interest, the per-individual interest predictions may affect the display of user-generated comments in other ways, such as showing the reviews that are predicted to be of higher interest in different colors, highlighting, or using a larger font size. The layout of the interface presented to a user may also reflect user-specific information. For example, a user that is a frequent commenter may be provided an interface with a more prominent control for submitting comments, while a user that tends to skim through comments may be provided an interface that includes a greater number of comments.

According to one embodiment, summarization of comments is also performed based on user-specific interest scores. For example, a user may be presented with summaries or aggregate ratings of only those comments that exceed a certain threshold of interest score for the user. Similarly, summaries may be separately derived and displayed for comments with interest scores above a threshold, and for comments with interest scores below the threshold. Those comments that are selected for display to a user may also include a first set of comments that are selected because they have high interest scores, and another set that are selected because they have low interest scores.

A variety of factors may be used to predict, automatically, the interest each individual user would have in each user-generated comment. For example, interest predictions for a user may be based on the user's prior rating of comments, the ratings made by other users that are similar to the user, the textual content of comments, the textual content of the target subject matter, user-generated tags that have been supplied for the target subject matter, user-generated tags that have been supplied for comments, the degree to which comments are related to the subjects which they target, various types of profile and/or demographic information about the user, the user's social network connections, the authors of the comments, the author of the target subject matter, the user's propensity to comment, etc.

### Recommending User-Generated Comments

According to one embodiment, rather than display user-generated comments for a target subject matter in the order in which the comments were made, or in a manner that reflects the interest of the average user, a system is provided for recommending user-generated comments to users in a user-specific manner. For example, many user-generated comment environments allow user to mark “like” or “dislike” over existing user-generated comments. A recommendation system may learn from each user's past preferences so that when a user is reading a news article, the user-generated comments for that article may be automatically ranked according to the likelihood of them being liked by this user. Such a system may be used directly to create personalized presentation of user-generated comments, as well as enabling down-stream applications, such as personalized summarization.

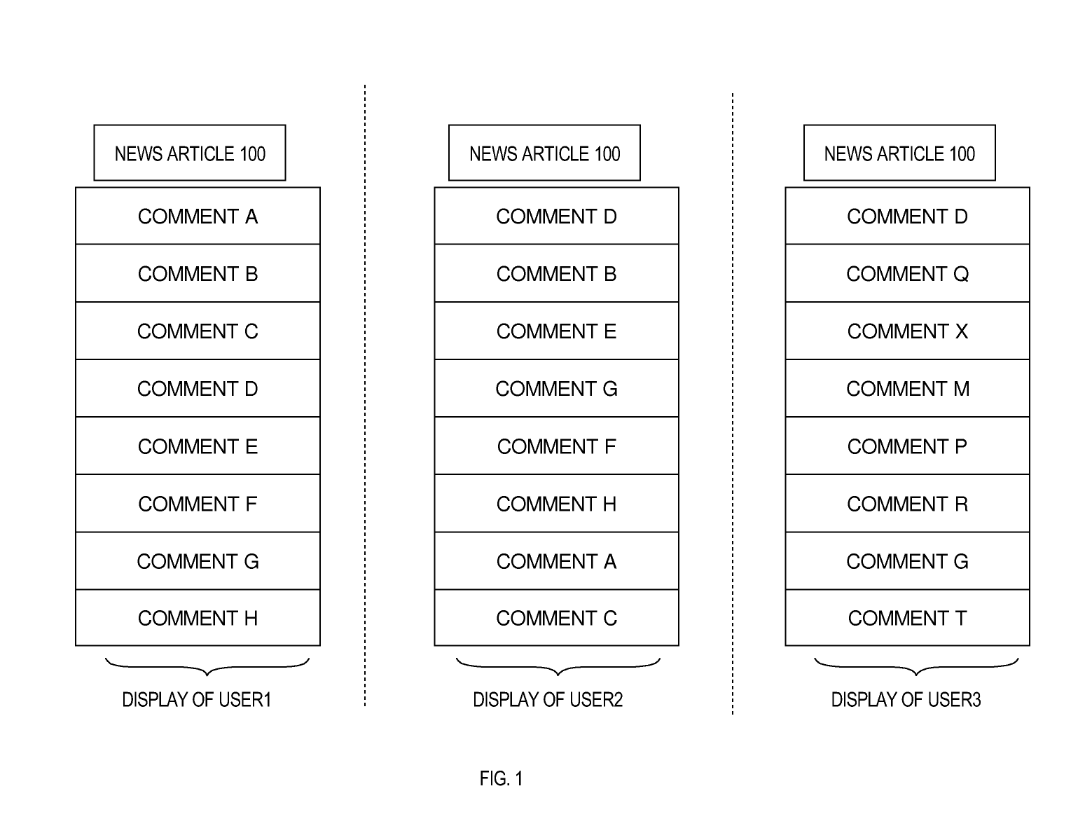

Referring to FIG. 1, it illustrates displays that may result by implementing a personalized comment recommendation system, according to an embodiment of the invention. For the purpose of explanation, assume that three users (user1, user2 and user3) request to view the same news article 100 at the same time. In response to the requests, a comment recommendation engine (not shown) determines user-specific interest scores for the comments associated with the article. Based on the user-specific interest scores, the comment recommendation engine determines which comments should be included on the webpage that is returned to each of the three users, and the order in which the comments are presented.

In the example illustrated in FIG. 1, the same comments were selected for user1 and user2, but the order in which the comments are presented differs based on the differences in the interest scores that those comments produced relative to user1 and user2. The comments that are selected and displayed to user3, on the other hand, include many comments that were not displayed to user1 and user2, and are missing some of the comments that were displayed to user1 and user2.

FIG. 1 is merely one example of how the display of comments, from the comment pool of the same target subject matter, may differ from user to user based on user-specific interest scores generated for the comments. In alternative embodiments, the difference in interest scores of the comments may be reflected in other ways, such as the font size of the comments, the color of the comments, the amount of text shown in the initial display of the comments (where more text is initially shown for comments that are predicted to be of higher interest), etc.

### Comment Recommendations Vs Content Recommendations

A recommendation system for user-generated comments differs in a variety of ways from a system that recommends target subject matter, such as articles, to users. Specifically, recommending articles is largely about identifying the topics of interest to a given user, and it is conceivable that unigram representation of full-length articles can reasonably capture that information. In contrast, most user-generated comments for an article a user is reading are already of interest to that user topically. Which ones the user like may depend on several non-topical aspects of the text, such as: whether the user agrees with the viewpoint expressed in the user-generated comment, whether the user-generated comment is convincing and well-written, etc. In addition, user-generated comments are typically much shorter than full length articles, so there is generally less content upon which to base any recommendations.

According to one embodiment, the difficulty in analyzing the textual information in user-generated comments can be alleviated by taking into account additional contextual information, such as author identities. If between a pair of users, one consistently likes or dislikes the other, then at least for the heavy users, this authorship information in itself could be adequate basis to determine whether a particular comment provided by one of the users would be of interest to the other user.

According to one embodiment, multiple sources of information are used for the task of recommending user-generated comments. For example, authorship information is used in addition to textual information. Examples of various sources, and how information from those sources may be used to generate per-user interest scores for user-generated comments, are provided in greater detail hereafter.

### Rater Affinity

According to one embodiment, one factor used to automatically determine personalized interest scores is rater affinity to the user-generated comments. According to one embodiment, rater affinity is determined using a model that incorporates rater-comment interactions and rater-author interactions simultaneously in a principled fashion. The model also provides a seamless mechanism to transition from cold-start (where recommendations need to be made for users or items with no or few past ratings) to warm-start scenarios—with a large amount of data, it fits a per-rater (author) model; with increase in data sparsity, the model applies a small sample size correction through features (e.g. textual features). For one embodiment, the exact formula for such corrections in the presence of sparsity is based on parameter estimates that are obtained by applying an EM algorithm to the training data.

### Example Model for Generating Interest Scores

A model is described herein for generating personalized interest scores for user-generated comments, according to an embodiment of the invention. This model is merely one example of how personalized interest scores may be generated, and the techniques described herein are not limited to any particular model, not any particular set of factors used by the model.

For the purpose of describing the model, yᵢⱼ denotes the rating that user i, called the rater, gives to user-generated comment j. Because suffix i is used to denote a rater and suffix j to denote a user-generated comment, xᵢ (of dimension pᵤ) and xⱼ (of dimension p_{c}) denote feature vectors of user i and user-generated comment j, respectively. For example, xᵢ can be the bag of words representation (a sparse vector) inferred through text analysis on user-generated comments voted positively by user i in the past, and xⱼ can be the bag of words representation for user-generated comment j. In addition, a(j) is used to denote the author of user-generated comment j, and use μᵢⱼ to denote the mean rating by rater i on user-generated comment j, i.e., μᵢⱼ=E(yᵢⱼ). μᵢⱼ cannot be estimated empirically since each user i usually rates a user-generated comment j at most once.

According to one embodiment, a generalized linear model framework is used (McCullagh and Nelder, 1989) that assumes μᵢⱼ (or some monotone function h of μᵢⱼ) is an additive function of:
(1) the rater bias i of user i since some users may have a tendency of rating user-generated comments more positively or negatively than others,
(2) popularity j of user-generated comment j, which could reflect the quality of the user-generated comment in this setting, and
(3) the author reputation γₐ₍ⱼ₎ of user a(j) since user-generated comments by a reputed author may in general get more positive ratings. Thus, the overall bias is αi+βj+γₐ₍ⱼ₎.

In addition to the bias, one embodiment includes terms that capture interactions among entities (raters, authors, user-generated comments). In addition, latent factors are attached to each rater, author and user-generated comment. These latent factors are finite dimensional Euclidean vectors that are unknown and estimated from the data. They provide a succinct representation of various aspects that are important to explain interaction among entities. In one embodiment, the following factors are used:
(a) user factor vᵢ of dimension rv(≧1) to model rater-author affinity,
(b) user factor uᵢ and user-generated comment factor cⱼ of dimension rᵤ(≧1) to model rater-comment affinity.

Intuitively, each could represent viewpoints of users or user-generated comments along different dimensions.

Affinity of rater i to user-generated comment j by author a(j) is captured by:
(1) similarity between viewpoints of users i and a(j), measured by v′ᵢvₐ(j); and
(2) similarity between the preferences of user i and the perspectives reflected in user-generated comment j, measured by u′ᵢcⱼ.

The overall interaction is v′ᵢvₐ₍ⱼ₎+u′ᵢcⱼ. Then, the mean rating μᵢⱼ or more precisely h(μᵢⱼ), is modeled as the sum of bias and interaction terms. Mathematically, it is assumed that:

yᵢⱼ˜N(μᵢⱼ,σ_{y}²) or Bernoulli(μᵢⱼ)

h(μᵢⱼ)=αᵢ+βⱼ+γₐ₍ⱼ₎+v′ᵢvₐ₍ⱼ₎+u′ᵢcⱼ

This equation shall be referred to hereafter as Equation 1.

For numeric ratings, the Gaussian distribution denoted by N(mean, var) is used. For binary ratings, the Bernoulli distribution is used. For Gaussian, h(μᵢⱼ)=μᵢⱼ, and for Bernoulli, it is assumed that:

$$h ( {μ}_{ij} ) = log \frac{{μ}_{ij}}{1 - {μ}_{ij}}$$

which is the commonly used logistic transformation.

The full model specified above is denoted as vv+uc since both user-user interaction v′ᵢvₐ₍ⱼ₎ and user-user-generated comment interaction u′ᵢcⱼ are modeled at the same time.

Latent factors: To estimate latent factors in Equation 1, a maximum likelihood estimation (MLE) approach does not work well because a large fraction of entities have small sample size. For instance, if a user-generated comment is rated only by one user and rᵤ>1, then the model is clearly overparametrized and the MLE of the user-generated comment factor would tend to learn idiosyncrasies in the training data.

Hence, in one embodiment, constraints are imposed on the factors to obtain estimates that generalize well on unseen data. A Bayesian framework may be used, where such constraints are imposed through prior distributions.

Priors that provide a good backoff estimate are needed when interacting entities have small sample sizes. For instance, to estimate latent factors of a user with little data, a backoff estimate that is obtained by pooling data across users with same user features is used. Such a pooling is performed through regression, the mathematical specification is given below.

αᵢ˜N(g′xᵢ,σ_{α}²),uᵢ˜N(Gxᵢ,σᵤ²),

βⱼ˜N(d′xⱼ,σ_{β}²),cⱼ˜N(Dxⱼ,σ_{c}²),

γₐ₍ⱼ₎˜N(0,σ_{γ}²),vᵢ˜N(0,σᵥ²),

where g^{p}^{ᵤ}^{×1} and d^{p}^{ᵤ}^{×1} are regression weight vectors, and G^{r}^{ᵤ}^{×p}^{ᵤ} and D^{r}^{ᵤ}^{×p}^{ᵤ} are regression weight matrices. These regression weights are learnt from data and provide the backoff estimate. Take the prior distribution of ui for example. The prior can be rewritten as uᵢ=Gxᵢ+δᵢ, where δᵢ˜N(0, σᵤ²).

If user i has no rating in the training data, uᵢ will be predicted as the prior mean (backoff) Gxᵢ, a linear projection from the feature vector xᵢ through matrix G learnt from data. This projection can be thought of as a multivariate linear regression problem with weight matrix G, one weight vector per dimension of uᵢ. However, if user i has many ratings in the training data, the per-user residual i that is not captured by the regression Gxᵢ is estimated. For sample sizes in between these two extremes, the per user residual estimate is “shrunk” toward zero, where the amount of shrinkage depends on the sample size, past user ratings, variability in ratings on user-generated comments rated by the user, and the value of variance components σ²^{^{−}}ₛ.

### Special Cases of Example Model

The full model (vv+uc) includes several existing models explored in collaborative filtering and social networks as special cases.

The matrix factorization model: This model assumes the mean rating of user i on item j is given by h(μᵢⱼ)=αᵢ+ β̅ⱼ+u′ᵢcⱼ, and the mean of the prior distributions on αᵢ, βⱼ, uᵢ, cⱼ are zero, i.e., g=d=G=D=0: Recent work clearly illustrates that this method obtains better predictive accuracy than classical collaborative filtering techniques based on item-item similarity (Bell et al. (2007)).

The uc model: This is also a matrix factorization model but with priors based on regressions (i.e., non-zero g; d; G; D). It provides a mechanism to deal with both cold and warm-start scenarios in recommender applications (Agarwal and Chen (2009)).
The vv model: This model assumes h(μᵢⱼ)=αᵢ+γₐ₍ⱼ₎+v′ᵢvₐ₍ⱼ₎. It was first proposed by Hoff (2005) to model interactions in social networks. The model was fitted to small datasets (at most a few hundred nodes) and the goal was to test certain hypotheses on social behavior, out-of-sample prediction was not considered.

The low-rank bilinear regression model: Here, h(μᵢⱼ)=g′xᵢ+d′xⱼ+x′iG′Dxⱼ.

This is a regression model purely based on features with no per user or per-user-generated comment latent factors. In a more general form, x′ᵢG′Dxⱼ can be written as x′ᵢAxⱼ, where is the matrix of regression weights (Chu and Park, 2009). However, since xᵢ and xⱼ are typically high dimensional, A can be a large matrix that needs to be learnt from data. To reduce dimensionality, one can decompose A as A=G′D, where the number of rows in D and G are small. Thus, instead of learning A, a low-rank approximation of A is learned. This ensures scalability and provides an attractive method to avoid over-fitting.

### Model Fitting

According to one embodiment, model fitting for the example model described above is based on the expectation-maximization (EM) algorithm (Dempster et al., 1977). For the purpose of explanation, a sketch of the algorithm for the Gaussian case is provided. The logistic model can be fitted along the same lines by using a variational approximation (see Agarwal and Chen (2009)).

Let Y={yᵢⱼ} denote the set of the observed ratings. In the EM parlance, this is “incomplete” data that gets augmented with the latent factors Θ={uᵢ, vᵢ, cⱼ} to obtain the “complete” data. The goal of the EM algorithm is to find the parameter η=(g, d, G, D, σ_{α}², σ_{β}², σᵤ², σᵥ², σ_{y}²) that maximizes the “incomplete” data likelihood Pr(Y|η)=∫Pr(Y,Θ|η)dΘ⁻ that is obtained after marginalization (taking expectation) over the distribution of Θ. Since such marginalization is not available in closed form for our model, the EM algorithm is used.

EM algorithm: The complete data log-likelihood l(η; Y, Θ) for the full model in the Gaussian case (where h(μᵢⱼ)=μᵢⱼ) is given by

$$\begin{matrix}l ( η ; Y , Θ ) = - \frac{1}{2} {\sum }_{ij}^{ } ( {( {y}_{ij} - {μ}_{ij} )}^{2} / {σ}_{y}^{2} + log {σ}_{y}^{2} ) \\ - \frac{1}{2} {\sum }_{i}^{ } ( {( {α}_{i} - {g}^{′} {x}_{i} )}^{2} / {σ}_{α}^{2} + log {σ}_{α}^{2} ) \\ - \frac{1}{2} {\sum }_{j}^{ } ( {( {β}_{j} - {d}^{′} {x}_{j} )}^{2} / {σ}_{β}^{2} + log {σ}_{β}^{2} ) \\ - \frac{1}{2} {\sum }_{i}^{ } ( {‖ {u}_{i} - {Gx}_{i} ‖}^{2} / {σ}_{u}^{2} + {r}_{u} log {σ}_{u}^{2} ) \\ - \frac{1}{2} {\sum }_{j}^{ } ( {‖ {c}_{j} - {Dx}_{j} ‖}^{2} / {σ}_{c}^{2} + {r}_{u} log {σ}_{c}^{2} ) , \\ - \frac{1}{2} {\sum }_{i}^{ } ( {v}_{i}^{′} {v}_{i} / {σ}_{v}^{2} + {r}_{v} log {σ}_{v}^{2} + {γ}_{i}^{2} / {σ}_{γ}^{2} + log {σ}_{γ}^{2} ) ,\end{matrix}$$

where rᵤ is the dimension of factors uᵢ and cⱼ, and rᵥ is the dimension of vᵢ. Let η^{(t)} denote the estimated parameter setting at the t^{th} iteration. The EM algorithm iterates through the following two steps until convergence.

E-step: fₜ(η)=E_{Θ}[l(η; Y, Θ)|η^{(t)}] as a function of η, where the expectation is taken over the posterior distribution of (Θ|η^{(t)}, Y).

Note that here η is the input variable of function fₜ, but η^{(t)} consists of known quantities (determined in the previous iteration).

M-step: Find the η that maximizes the expectation computed in the E-step.

$${η}^{( t + 1 )} = arg {max}_{η} {f}_{t} ( η )$$

Since the expectation in the E-step is not available in a closed form, a Gibbs sampler is used to compute the Monte Carlo expectation (Booth and Hobert, 1999). The Gibbs sampler repeats the following procedure L times. It samples αᵢ, γᵢ, βⱼ, uᵢ, vⱼ and cⱼ sequentially one at a time by sampling from the corresponding full conditional distributions. The full conditional distributions are all Gaussian, hence they are easy to sample. Once a Monte Carlo expectation is calculated from the samples, an updated estimate of η is obtained in the M-step. The optimization of variance components σ²ₛ in the M-step is available in closed form, the regression parameters are estimated through off-the-shelf linear regression routines. The posterior distribution of latent factors for known η is multi-modal, and the Monte Carlo based EM method tends to outperform other optimization methods like gradient descent in terms of predictive accuracy.

### Example Applications of Model

The example model described above may be applied in many contexts to generate per-user-per-comment interest scores, and to present user-generated comments in a manner that is based on those interest scores. For example, the model may be applied in a situation where users read and comment on articles (such as news articles, blogs posts, status updates, event announcements, etc.), and have a mechanism for rating the comments. Information about how users actually rated the comments may be collected and used as a training set. Specifically, a portion of the collected data may be used for training, a portion for tuning, and a portion for testing the accuracy of the model.

To obtain comment-specific features, all comments may be tokenized, lower-cased, with stopwords and punctuations removed. Further, the tokens may be filtered so that only the N most frequently used tokens are considered (where N may be, for example, 10,000). According to one embodiment, a rater feature vector is created by summing over the feature vectors of all comments rated positively by the rater.

Various methods may be used to apply the example model to produce per-user-per-comment interest scores. For example, various embodiments may use any one or any combination of the full model vv+uc, as well as the three main special cases, vv, uc, and bilinear. The dimensions of vᵢ, uᵢ and cⱼ (i.e., rᵥ and rᵤ), and the rank of bilinear are selected to obtain the best AUC on the tuning set. In one particular implementation, rᵥ=2; rᵤ=3 and rank of bilinear is 3. In addition, the following baseline methods may be used to predict per-user preferences in isolation, primarily based on textual information.

Cosine similarity (cos): x′ᵢxⱼ. This is simply based on how similar a new comment j is to the comments rater i has liked in the past.

Per-user SVM (svm): For each rater, train a support vector machine (SVM) classifier using only comments (xⱼ) rated by that user.

Per-user Naive Bayes (nb): For each rater, train a Naive Bayes classifier using only comments (xⱼ) rated by that user.

SVMs typically yield the best performance on text classification tasks. A Naive Bayes classifier can be more robust over shorter text spans common in user comments given the high variance.

### Factors that May be Used to Determine Interest Scores

The example model described above uses various factors to determine per-user-per-comment interest scores. However, the factors used by the example model are merely some of the virtually limitless factors that may be used to determine how interested a specific user would be in each specific user-generated comment. A non-exhaustive list of factors that may be used individually or in any combination to determine individualized interest scores for user-generated comments for a particular reader includes:
comment-specific features
   textual features of the comments
   tags applied to the comments
   age of the comments
   length of the comments
   time of day at which comments were submitted
   rating of this comment by other readers
   similarity between text of comments and text of target subject matter
   similarity between tags applied to comments and tags applied to target subject matter
author-specific features
   prior ratings of author's comments by all readers
   prior ratings of author's comments by this reader
   profile of author (e.g. age, location, gender, political affiliation, religion, group memberships, etc.)
   degrees of separation between author and reader in a social network
reader-specific features
   profile of the reader (e.g. age, location, gender, political affiliation, religion, group memberships, etc.)
   prior comment ratings by reader
   prior comment ratings by readers that are determined to be similar to the reader
   prior comment ratings by all readers
   confidence level of interest scores generated for this reader (may be low for readers for which little prior data is available)
   prior online behavior of reader outside comment rating context (e.g. web pages the reader has visited, search queries the reader has submitted, etc.)
environment-specific features
time of day that user-generated comment recommendation is being generated
nature of computing device being used by reader
current geographic location of reader
target-subject-matter-specific features
   number of comments target subject matter has received
   topic or category of target subject-matter
   textual features of target subject matter
   tags applied to the target subject matter

### Personalized Presentation of Comment Recommendations

As mentioned above, once interest scores have been determined for a particular user for a particular set of user-generated comments, the particular user is provided a presentation of the user-generated comments that is personalized based on the interest scores. The number of ways the presentation can be personalized based on the interest scores is virtually endless. Two relatively simple forms of personalization include selecting which comments to show based on the interest scores, and determining the ranking of the comments based on the interest scores. However, there are any number of other ways the display of the comments may be personalized instead of or in addition to selection and ranking. Examples of ways to personalize the presentation of comments include:
personalized layout of the display that includes the comments
   a larger region of the display for listing comments for users that tend to browse comments
   a larger region of the display for entering a comment for users that frequently submit comments
   a larger region of the display for listing comments when the target subject matter is a topic of high interest to the user
   pop-ups for comments with exceptionally high scores (e.g. comments made by the user's “friends”)
   in-place annotations for comments with exceptionally high scores
   comments with exceptionally high scores shown in a different location than other comments
personalized listing of comments
   comments ordered (ranked) by interest scores
   comments grouped by interest scores (e.g. high, medium, and low scoring comment groups)
   font, color, size, highlights, frame of comment varies based on interest scores
   comments with scores below a threshold are hidden
personalized summarization of comments
   separate comment summaries for high-scoring, medium-scoring and low-scoring comments
   exclude from summaries all comments whose interest scores fall below a threshold

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

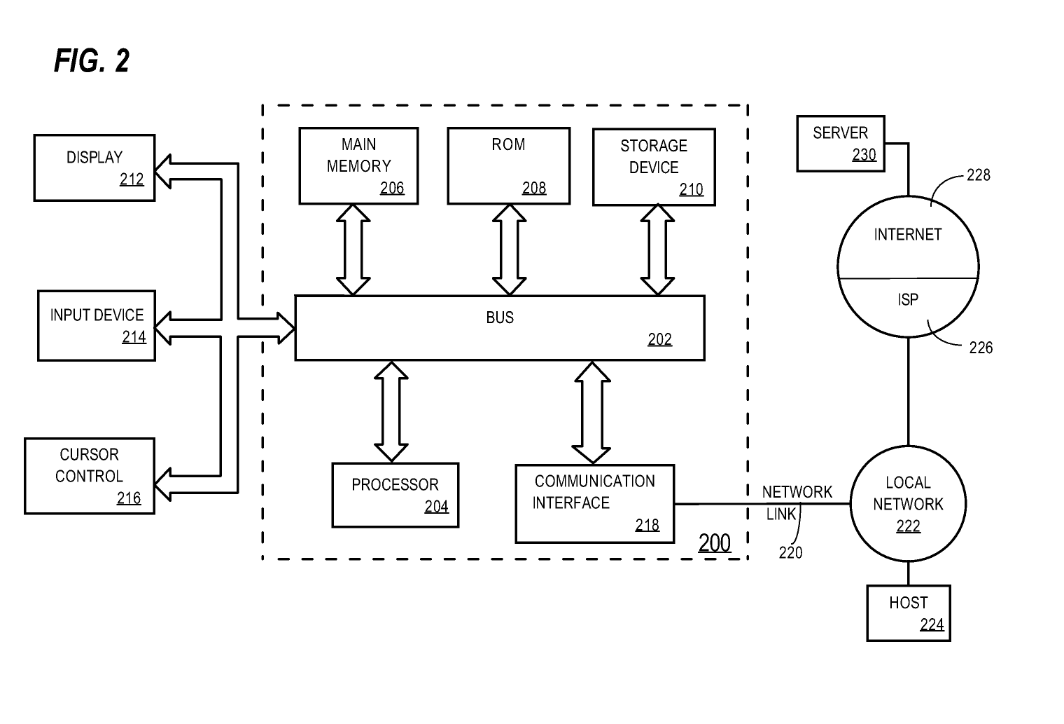

For example, FIG. 2 is a block diagram that illustrates a computer system 200 upon which an embodiment of the invention may be implemented. Computer system 200 includes a bus 202 or other communication mechanism for communicating information, and a hardware processor 204 coupled with bus 202 for processing information. Hardware processor 204 may be, for example, a general purpose microprocessor.

Computer system 200 also includes a main memory 206, such as a random access memory (RAM) or other dynamic storage device, coupled to bus 202 for storing information and instructions to be executed by processor 204. Main memory 206 also may be used for storing temporary variables or other intermediate information during execution of instructions to be executed by processor 204. Such instructions, when stored in non-transitory storage media accessible to processor 204, render computer system 200 into a special-purpose machine that is customized to perform the operations specified in the instructions.

Computer system 200 further includes a read only memory (ROM) 208 or other static storage device coupled to bus 202 for storing static information and instructions for processor 204. A storage device 210, such as a magnetic disk or optical disk, is provided and coupled to bus 202 for storing information and instructions.

Computer system 200 may be coupled via bus 202 to a display 212, such as a cathode ray tube (CRT), for displaying information to a computer user. An input device 214, including alphanumeric and other keys, is coupled to bus 202 for communicating information and command selections to processor 204. Another type of user input device is cursor control 216, such as a mouse, a trackball, or cursor direction keys for communicating direction information and command selections to processor 204 and for controlling cursor movement on display 212. This input device typically has two degrees of freedom in two axes, a first axis (e.g., x) and a second axis (e.g., y), that allows the device to specify positions in a plane.

Computer system 200 may implement the techniques described herein using customized hard-wired logic, one or more ASICs or FPGAs, firmware and/or program logic which in combination with the computer system causes or programs computer system 200 to be a special-purpose machine. According to one embodiment, the techniques herein are performed by computer system 200 in response to processor 204 executing one or more sequences of one or more instructions contained in main memory 206. Such instructions may be read into main memory 206 from another storage medium, such as storage device 210. Execution of the sequences of instructions contained in main memory 206 causes processor 204 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 210. Volatile media includes dynamic memory, such as main memory 206. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 202. Transmission media can also take the form of acoustic or light waves, such as those generated during radio-wave and infra-red data communications.

Various forms of media may be involved in carrying one or more sequences of one or more instructions to processor 204 for execution. For example, the instructions may initially be carried on a magnetic disk or solid state drive of a remote computer. The remote computer can load the instructions into its dynamic memory and send the instructions over a telephone line using a modem. A modem local to computer system 200 can receive the data on the telephone line and use an infra-red transmitter to convert the data to an infra-red signal. An infra-red detector can receive the data carried in the infra-red signal and appropriate circuitry can place the data on bus 202. Bus 202 carries the data to main memory 206, from which processor 204 retrieves and executes the instructions. The instructions received by main memory 206 may optionally be stored on storage device 210 either before or after execution by processor 204.

Computer system 200 also includes a communication interface 218 coupled to bus 202. Communication interface 218 provides a two-way data communication coupling to a network link 220 that is connected to a local network 222. For example, communication interface 218 may be an integrated services digital network (ISDN) card, cable modem, satellite modem, or a modem to provide a data communication connection to a corresponding type of telephone line. As another example, communication interface 218 may be a local area network (LAN) card to provide a data communication connection to a compatible LAN. Wireless links may also be implemented. In any such implementation, communication interface 218 sends and receives electrical, electromagnetic or optical signals that carry digital data streams representing various types of information.

Network link 220 typically provides data communication through one or more networks to other data devices. For example, network link 220 may provide a connection through local network 222 to a host computer 224 or to data equipment operated by an Internet Service Provider (ISP) 226. ISP 226 in turn provides data communication services through the world wide packet data communication network now commonly referred to as the “Internet” 228. Local network 222 and Internet 228 both use electrical, electromagnetic or optical signals that carry digital data streams. The signals through the various networks and the signals on network link 220 and through communication interface 218, which carry the digital data to and from computer system 200, are example forms of transmission media.

Computer system 200 can send messages and receive data, including program code, through the network(s), network link 220 and communication interface 218. In the Internet example, a server 230 might transmit a requested code for an application program through Internet 228, ISP 226, local network 222 and communication interface 218.

The received code may be executed by processor 204 as it is received, and/or stored in storage device 210, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
receiving user-generated comments related to a particular target subject matter;
for a first user, generating first interest scores that indicate how much interest the first user would have in each of the user-generated comments;
wherein the first interest scores generated for the first user are based, at least in part, on information that is specific to the first user; and
displaying the user-generated comments to the first user in a user-specific manner that is based, at least in part, on the first interest scores;
wherein the method is performed by one or more computing devices.

2. The method of claim 1 further comprising:
for a second user, generating second interest scores that indicate how much interest the second user would have in each of the user-generated comments;
wherein the first interest scores are different than the second interest scores;
wherein the second interest scores generated for the second user are based, at least in part, on information that is specific to the second user; and
displaying the user-generated comments to the second user in a user-specific manner that is based, at least in part, on the second interest scores.

3. The method of claim 2 wherein the user-generated comments are displayed in a different order to the first user than to the second user.

4. The method of claim 2 further comprising:
selecting a first subset of the user-generated comments to display to the first user based on the first interest scores;
selecting a second subset of the user-generated comments to display to the second user based on the second interest scores;
wherein the first subset is different than the second subset.

5. The method of claim 1 wherein:
the particular target subject matter is an article; and
the user-generated comments are comments about the article.

6. The method of claim 1 wherein the user-generated comments are user reviews of the particular target subject matter.

7. The method of claim 1 wherein the first interest scores are based, at least in part, on one or more comment-specific features.

8. The method of claim 1 wherein the first interest scores are based, at least in part, on one or more author-specific features.

9. The method of claim 1 wherein the first interest scores are based, at least in part, on profile information about the first user.

10. The method of claim 1 wherein the first interest scores are based, at least in part, on prior comment ratings submitted by the first user.

11. The method of claim 1 wherein the first interest scores are based, at least in part, on features specific to the particular target subject matter.

12. A method comprising:
receiving user-generated comments related to a particular target subject matter;
displaying the user-generated comments to a first user in a first user-specific manner that is based, at least in part, on information that is specific to the first user; and
displaying the user-generated comments to a second user in a second user-specific manner that is based, at least in part, on information that is specific to the second user;
wherein the first user-specific manner is different than the second user-specific manner;
wherein the method is performed by one or more computing devices.

13. The method of claim 12 wherein the first user-specific manner uses a first personalized display layout and the second user-specific manner uses a second personalized display layout that is different than the first personalized display layout.

14. The method of claim 12 wherein the first user-specific manner ranks the user-generated comments in a first order, and the second user-specific manner ranks the user-generated comments in a second order that is different than the first order.

15. The method of claim 12 wherein:
both the first user-specific manner and the second user-specific manner establish groups for the user-generated comments; and
membership of the groups displayed to the first user is different than membership of the groups displayed to the second user.

16. One or more non-transitory computer-readable media storing instructions for performing a method, wherein the method comprises:
receiving user-generated comments related to a particular target subject matter;
displaying the user-generated comments to a first user in a first user-specific manner that is based, at least in part, on information that is specific to the first user; and
displaying the user-generated comments to a second user in a second user-specific manner that is based, at least in part, on information that is specific to the second user;
wherein the first user-specific manner is different than the second user-specific manner.

17. The one or more non-transitory computer-readable media of claim 16 wherein displaying the user-generated comments to the first user in the first user-specific manner includes:
for the first user, generating first interest scores that indicate how much interest the first user would have in each of the user-generated comments;
wherein the first interest scores generated for the first user are based, at least in part, on the information that is specific to the first user; and
displaying the user-generated comments to the first user in a manner that is based, at least in part, on the first interest scores.

18. The one or more non-transitory computer-readable media of claim 16 wherein:
the particular target subject matter is an article; and
the user-generated comments are comments about the article.

19. The one or more non-transitory computer-readable media of claim 16 wherein the user-generated comments are user reviews of the particular target subject matter.

20. The one or more non-transitory computer-readable media of claim 16 wherein the first user-specific manner uses a first personalized display layout and the second user-specific manner uses a second personalized display layout that is different than the first personalized display layout.
